(19) United States
(12) Patent Application Publication
(10) Pub. No.: US 2009/0195395 A1
(43) Pub. Date: Aug. 6, 2009

(54) Supply And Control Device Of A Light Source

(75) Inventors: Giovanni Cannistra, Bologna (IT); Gianni Facchini, San Carlo (Ferrara) (IT); Gianluigi Basile, Argelato (Bologna) (IT)

Correspondence Address: WILLIAM J. SAPONE;COLEMAN SUDOL SAPONE P.C., 714 COLORADO AVENUE, BRIDGE PORT, CT, 06605, US

(73) Assignee: O.C.E.M. S.P.A., S. Giorgio di Piano (Bologna) (IT)

(21) Appl. No.: 12/304,371

(22) PCT Filed: Jun. 12, 2007
(86) PCT No.: PCT/EP2007/055783

§ 371 Date: Dec. 11, 2008

(30) Foreign Application Priority Data
Jun. 13, 2006 (IT) BO2006A000455

(51) Int. Cl. G08B 17/12

(52) U.S. Cl. 340/600

(57) ABSTRACT

A device for supplying and controlling a light source in a half-dipped signaling lamp includes at least one light source (3), housed in a base support, and a cap (4), removably fastened to the support base. At least one window seat (5a, 5b) is made in the cap and an optical prism (6a, 6b) is associated to the window seat. Reflecting means (7) direct a light beam emitted by the light source (3) toward the optical prism (6a, 6b) while sensor means (21) detect the intensity of the light radiation emitted by the light source (3) or of a representative quantity of the light radiation. A supply and control central unit (CC) receives the signals (S1, S2), coming from the sensor means (21) and supplies the light source (3).

### BACKGROUND OF THE INVENTION

The present invention relates to a device for supply and control of a light source; by way of example, light sources situated inside the half-dipped signaling lamps, situated along the airport runways, are considered.

### DESCRIPTION OF PRIOR ART

As it is known, each airport runway is served by at least a supply system SA (see block diagram in FIG. 1A), which includes an apparatus AA, electrically connected to a plurality of half-dipped signaling lamps SL₁, SL₂, . . . SLₙ, situated in cascade, to define with the latter a closed loop circuit, aimed at supplying signaling lamps SL₁, SL₂, . . . , SLₙ with an electric current z having variable intensity (as far as its efficient value is concerned) as a function of the values assumed by a control signal k applied to the input of the apparatus AA; such a control signal k, for example, is transmitted from the control tower (not shown) and defines, on the basis of a prefixed value scale, the lighting level that the runaway must provide according to contingent visibility level (twilight, night, hostile weather conditions, etc.)

The Patent Application No. B02005A000606, owned by the same Applicant, refers to a “Half-dipped signaling lamp” and is particularly relevant for defining the technical scope of the present invention.

Such half-dipped signaling lamp (also known to those skilled in the field as light signal) includes a base support, aimed at being embedded in the ground and a cap protruding from the latter, removably fastened thereto and carrying e.g. two groups of light sources, each including three light-emitting diodes or LEDs, arranged one beside another, and reflecting means.

The cap has two seats equipped with windows, which house corresponding optical prisms.

Advantageously, the reflecting means are functionally interposed between each group of LEDs and the corresponding optical prism, so as to maximize the percentage of the light beams going out from the relative window seat and consequently, the luminous efficacy.

The lower part of the base support houses an electronic central unit C, which supplies each group of LED and allows to check its operation state and physical integrity.

In particular, the fault of a LED (premature or at the end of its service life), which causes its turning off, is deduced indirectly by the central control unit C, which detects its alteration from the electric characteristics: actually, unlike the incandescent lamps, the current continues to circulate in a faulty diode, although in an anomalous way, thus complicated control techniques are arranged to identify the fault by the variation of the diode absorption property.

Therefore, this type of control is an “ON/OFF” one, that is the control circuitry is able to detect if each diode is turned on, turned off, or faulty, i.e. it does not emit any light beam; moreover, the diodes state is monitored only indirectly, by the analysis of their electric characteristics.

Regulations in force concerning the light sources used along the airport runaways impose a light intensity defined on the basis of minimum values to be respected, which according to a known standard can be obtained for example by applying to an incandescent lamp current values of 2.8, 3.4, 4.1, 5.2 and 6.6 amp; in this connection, different light values are defined, which can lighten the runaways according to contingent visibility (twilight, night, hostile weather conditions, etc.).

At present, the apparatus AA supplies the light signal devices SL₁, SL₂, . . . , SLₙ exactly with a current z having one of the above mentioned current values, depending on the control signal k; the central control unit C of each light signal device SL₁, SL₂, . . . , SLₙ, in turn, supplies (in known way, on a secondary, separate circuit) the LED, made in the light signal devices, with the current values being function of those of the supplying current z, determining corresponding amounts of light emission, which depend partly on the operation time of the same diodes.

Actually, it is necessary to take into consideration the curve representing the variation of the light intensity, in time, of a diode, through which the same nominal current has passed.

The curve trend reports a drop of about 30-40% of light intensity within 50000 hours of service life.

Effectively, the supplying of the diodes with a current having the above mentioned values determines corresponding light emission values, which in average, are higher that the ones required by the regulations for a first period of service life (for example, between 0 and 10000 hours of operation) and settle down at values substantially near to those required by the regulations, close to the 50000 hours of operation, due just to the diodes performance decrease.

### SUMMARY OF THE INVENTION

In the light of what above, as it is known to those skilled in the field, the object of the present invention is to propose a newly conceived device for supplying and controlling signaling sources, which is based, in an innovative way, on the measure of the intensity of luminous flux emitted by the same light sources, so as to check their operation state (turning on/off, performance decrease in time, fault or malfunctioning), and to adjust in optimal way their supply current, according to the regulations in force concerning the airport environment and allowing the maximum energy saving.

Another object of the present invention is to propose a device which is functional, reliable, whose structure is essential and costs are relatively contained with respect to the advantages to be obtained.

The above mentioned objects are obtained, in accordance with the contents of the claims, by a supply and control device for a light source characterized in that it includes:

sensor means for detecting the intensity of the light radiation emitted by said light source or a representative quantity thereof; and

a central supply and control unit receiving signals coming from said sensor means and supplying said light source to adjust the intensity of the light radiation emitted thereby.

According to the invention, a device is provided for supplying and controlling a light source in a half-dipped signaling lamp, with the signaling lamp including:

a base support embedded in the ground;

at least said light source housed in said base support;

a cap, protruding from the ground and removably fastened to said base support; at least one window seat made in said cap;

an optical prism connected to said window seat to direct outwards a light beam emitted by the light source,

characterized in that it includes sensor means for detecting the intensity of the light radiation emitted by said light source or a representative quantity of said light radiation; and

a central supply and control unit receiving signals coming from said sensor means and supplying said light source to adjust the intensity of the light radiation emitted by said light source.

### BRIEF DESCRIPTION OF THE DRAWINGS

The characteristic features of the invention, not appearing from what has just been said, will be better pointed out in the following, in accordance to what is reported in the claims and with help of the enclosed drawings, in which:

FIG. 1A is a block diagram of a system for supplying a plurality of half-dipped signaling lamps, substantially known in the airport environment;

FIGS. 1, 2 are plan views, respectively from top and from bottom, of a covering cap of a half-dipped signaling lamp, whose light sources are subjected to the supply and control device proposed by the present invention;

FIG. 3 is a plan view, in an enlarged scale, of a significant element of the half-dipped signaling lamp;

FIG. 4 is a partial, bottom view, in the same scale as FIG. 3, of the covering cap, during a particularly significant operation configuration of the half-dipped signaling lamp;

FIG. 5 is a schematic, section view taken along A-A of FIG. 4;

FIG. 6 is a schematic, lateral section of the half-dipped signaling lamp and of the associated supply and control device, according to an embodiment.

### BEST MODES OF CARRYING OUT THE INVENTION

As it has been already pointed out, the object of the present invention relates to a device for supply and control of light sources; by way of example, the ones of a half-dipped signaling lamp will be considered in the following.

With reference to the enclosed drawings, the reference numeral 1 indicates, as a whole, the half-dipped signaling lamp, partly known from the previously mentioned Application no. BO2005A000606, shown as an example, and the numeral 20 indicates the associated supply and control device, proposed by the present invention.

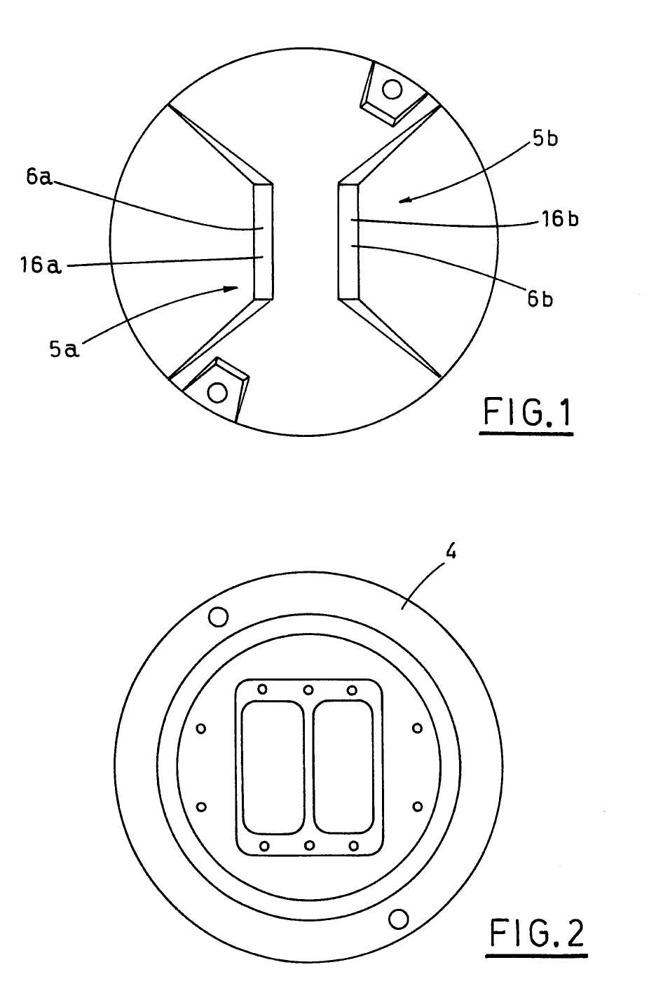

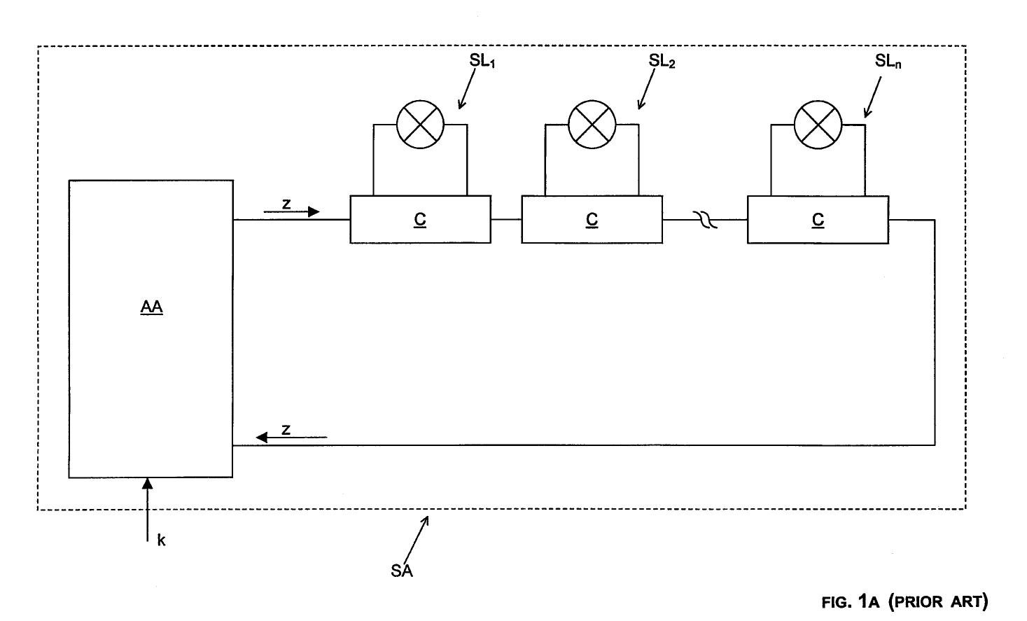

The half-dipped signaling lamp 1 is controlled by the supply apparatus AA, like the half-dipped signaling lamps SL₁, SL₂, . . . , SLₙ of known type shown in FIG. 1.

The half-dipped signaling lamp 1 includes a base support (not shown), aimed at being embedded in the ground, and having, removably fastened thereto, a cap 4, protruding from the ground and having a pair of window seats 5a, 5b, facing each other.

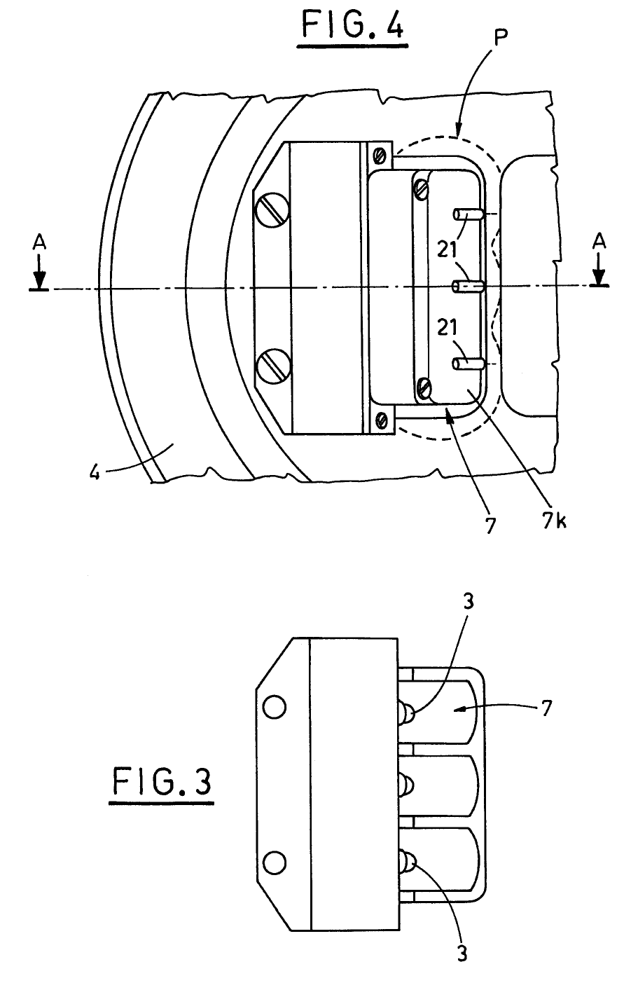

An optical prism 6a, 6b is rigidly associated to the cap 4, so as to direct outside the light beams emitted by a respective group of light-emitting diodes (LEDs) 3, for example three, housed inside the base support (see FIGS. 3, 4).

Reflecting means 7 are functionally interposed between each group of diodes 3 and the corresponding optical prism 6a, 6b, and are aimed at directing the light beams emitted by each group of LEDs 3 toward the corresponding optical prism 6a, 6b, so as to maximize the percentage of the light beams leaving the relevant window seat 5a, 5b.

As it has been explained in detail in the document BO2005A000606, the reflecting means 7 include e.g. surfaces 7a, having parabolic sections, having corresponding LEDs 3 placed on their foci, to obtain a substantially parallel light beam, coming out of the window seat 5a, 5b.

The supply and control device 20, proposed by the invention and forming an integral part of the half-dipped signaling lamp 1, includes: sensors 21, of known type, for measuring the intensity of a light radiation, whose number is equal to the number of the light-emitting diodes 3 and which are arranged along the outer, inoperative wall 7k of the reflecting means 7, aimed at detecting the intensity of a light radiation emitted by the diodes 3 and reflected on the inner surface of the cap 4, as it will be better explained later; and a central supply and control unit CC receiving the supply current z and receiving signals S1, S2 from the sensors 21, for controlling the diodes 3 supply by signals D1, D2, respectively.

The supply current z corresponds for example to current values of 2.8, 3.4, 4.1, 5.2 and 6.6 amp, as mentioned in the introductory note, to which at least the minimum values of intensity of the light emitted by the half-dipped signaling lamp 1, and established by the regulations, must correspond.

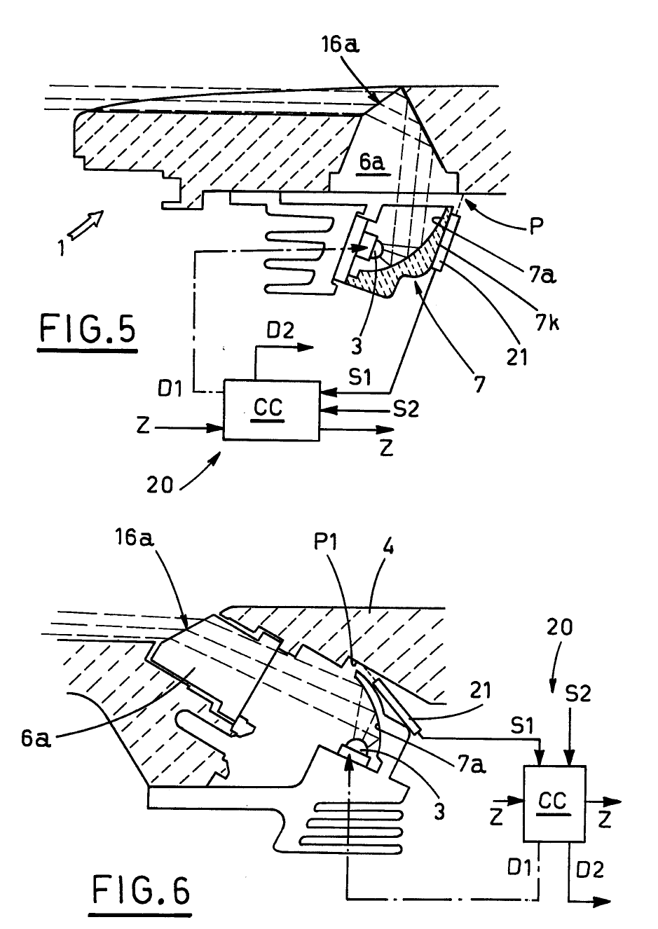

Taken into consideration that the structure of the half-dipped signaling lamp 1 is symmetrical, later on reference will be made, in this particular case, to the part of the half-dipped signaling lamp 1 shown in FIGS. 4, 5, 6, although completely analogous considerations will be extended to the not shown part.

The broken line of FIG. 4 delimits schematically a portion P of an inner surface of the cap 4, which is uniformly hit by the reflection of a part of light radiation emitted by the group of diodes 3, when all of them are turned on; a possible turning off of a diode LED 3, intentional or caused by a failure, would provoke a considerable variation of the form of the inner surface portion P, so as to make it easy to identify the turned off diode 3.

Advantageously, the sensors 21 are arranged along the wall 7k one beside the other, so as to meter the intensity of the light radiation, emitted by the group of LED 3 and reflected on this portion P of surface: consequently, the signals SI emitted by the sensors 21 and acquired by the central supply and control unit CC, contain detailed information about the operation state of the light-emitting diodes 3, that is the value of the intensity of the luminous flux emitted by the latter (except for corrective factors), and the operation state of each of them (turning on, turning off, performance decrease in time, fault or malfunctioning), since a direct measure of the intensity of the light radiation is available.

On the basis of the acquired signals S1 and the value of the supply current z (as said before, having values of 2.8, 3.4, 4.1, 5.2 e 6.6 amp), the central supply and control unit CC modulates the supply current fed to the diodes 3 by the control signals D1, so that corresponding light intensity values are emitted by the diodes 3, equal to or little higher than, e.g. the minimum ones fixed by the regulations in force.

The innovative character of the present invention and considerable technical-functional advantages, correlated thereto, appear from what above: the value of the light radiation intensity emitted by the group of diodes 3 can be quantified indirectly from the measure, performed by the sensors 21, of the light radiation intensity reflected on the portion P of surface; in this connection, the central supply and control unit CC can adjust the diodes 3 supplying current on the basis of specifications of required lighting, in accordance also with the regulations in force.

In this way, a feedback system is defined, with all the positive implications resulting therefrom, such as a considerable energy saving and a substantial increase of the diodes service life.

Therefore, it is possible to keep under control the operation state of the diodes 3 (turning on, turning off, performance decay in time, fault or malfunctioning), and the level of their electromagnetic emissions: in this connection, it is to be noted that the sensors 21 can measure a radiation spectrum which includes not only luminous one, but also the infrared field; this allows to extrapolate the value of the diodes LED 3 joining temperature, which, as it is known, affects its life duration.

Consequently, monitoring these values by the central supply and control unit CC and storing them therein, allows for example to keep trace of the estimated LED life and to program advantageously their substitution before their service life ends, thus giving improved reliability to the signaling lamp as a whole.

Another advantage of the present invention lies in the fact that a device has been set up for supplying and controlling a half-dipped signaling lamp, whose structure is flexible, functional, and essential, and whose costs are relatively limited with respect to the obtained advantages.

Moreover, the smaller structural complexity of the device according to the invention, increases considerably its reliability with respect to the known solutions.

Further, in case of a failure or malfunction of one diode 3 of the group, the possibility to modulate, in controlled way, the luminous flux emitted by the diodes 3, allows advantageously to supply the remaining diodes with a higher current, so as to make up for the consequent photometric variation and for the reduction of the luminous flux of the half-dipped signaling lamp 1.

Otherwise, an additional, spare diode can be provided, to be kept usually turned off and aimed at being set in operation to substitute a failed or malfunctioning diode 3 of the group; further, such additional diode could be controlled together with the other diodes of the group, always or in some, particularly demanding load conditions, to reduce the electric load applied to each of them during the working.

All these contrivances increase still further the reliability of the signaling lamp in its whole.

A different embodiment of the half-dipped signaling lamp 1 has been shown in FIG. 6; the sensors 21 are still arranged along the inactive wall of the reflecting means 7 and measure the intensity of the light radiation emitted by the diodes 3 and reflected on a portion of inner surface P1 of the cap 4, therefore the operation of the supply and control device 20 remains unchanged.

According to an embodiment, remaining within the protective scope of the present invention, luminosity sensors 21 are arranged in a distinct area of the half-dipped signaling lamp 1, e.g. facing the light-emitting diodes 3, so as not to interfere with the particular conformation of the surfaces 7a of the reflecting means 7.

It is specified that the embodiments of the half-dipped signaling lamps, reported schematically in the enclosed figures, are only examples; the proposed device can be advantageously integrated into light indicators of different constructive types: in this case, it will be sufficient to arrange suitably the luminosity sensors, so as to reveal the intensity of the light radiation emitted by the light source, or a representative quantity thereof, such as the reflection of a part of the same light radiation on an inner surface of the cap.

Likewise, the luminosity sensors can be associated to each optical prism 6a, 6b (not shown in Figures), so as to measure the intensity of the light radiation emitted by the corresponding group of diodes 3, which is reflected on the relative optical prism 6a, 6b, directing toward the half-dipped signaling lamp 1; thus, the central supply and control unit CC, functionally connected to the sensors, can detect the cleanliness degree of the surfaces 16a, 16b of the respective optical prisms 6a, 6b, which are turned outwards. In this way, advantageously, the central supply and control unit CC can send a corresponding signal to an outer apparatus, so as to plan the half-dipped signaling lamp 1 cleaning in the best way.

Finally, it is specified that the contemporaneous operation of the two groups of diodes 3 of the half-dipped signaling lamp 1 does not jeopardize in any way the correct operation of the supply and control device 20.

It is understood that the device described by the present invention can be applied to any light source, different from the one considered above, contained in a case different from the half-dipped signaling lamp.

It is understood that what above has been described as a not limiting example, therefore possible practical-application variants remain within the protective scope of the invention as described above and claimed below.

1. A supply and control device for a light source characterized in that it includes:
sensor means (21) for detecting the intensity of the light radiation emitted by said light source (3) or a representative quantity of said light radiation intensity; and
a central supply and control unit (CC) receiving signals (S1, S2) coming from said sensor means (21) and supplying said light source (3) to adjust the intensity of the light radiation emitted by the light source.

2. A device for supplying and controlling a light source in a half-dipped signaling lamp, with the signaling lamp including:
a base support embedded in the ground;
at least said light source (3) housed in said base support;
a cap (4), protruding from the ground and removably fastened to said base support;
at least one window seat (5a, 5b) made in said cap;
an optical prism (6a, 6b) connected to said window seat to direct outwards a light beam emitted by the light source (3),
characterized in that it includes sensor means (21) for detecting the intensity of the light radiation emitted by said light source (3) or a representative quantity of said light radiation intensity; and a central supply and control unit (CC) receiving signals (S1, S2) coming from said sensor means (21) and supplying said light source (3) to adjust the intensity of the light radiation emitted by the light source.

3. A device, according to claim 2, wherein said half-dipped signaling lamp includes also reflecting means (7), functionally interposed between said light source (3) and said optical prism (6a, 6b) for directing a light beam emitted by said light source (3) toward said optical prism (6a, 6b ), whereas said sensor means (21) include at least one luminosity sensor (21) arranged to face an outer, inoperative wall (7k) of said reflecting means (7), and detecting intensity of a part of light radiation emitted by said light source (3) and reflected on a corresponding portion (P) of inner surface of the half-dipped signaling lamp (1), said intensity of reflected light radiation constituting said representative quantity of the light radiation emitted by the light source (3).

4. A device, according to claim 2, wherein said half-dipped signaling lamp includes also reflecting means (7), functionally interposed between said light source (3) and said optical prism (6a, 6b) for directing a light beam emitted by said light source (3) toward said optical prism (6a, 6b) and at least one group of three light-emitting diodes (3), arranged one beside another, whereas said sensor means (21) include as many luminosity sensors (21), arranged facing the outer, inoperative wall (7k) of said reflecting means (7), and each of them detecting the intensity of a part of said light radiation, emitted by said light source (3), which is reflected on a relative portion of inner surface (P) of the half-dipped signaling lamp (1), said intensity of reflected light radiation constituting said representative quantity of the light radiation emitted by the light-emitting diode (3).

5. A device, according to claim 4, wherein each portion of inner surface (P) of said half-dipped signaling lamp (1), on which said light radiation emitted by a corresponding light-emitting diode (3) is reflected, coincides in particular with a corresponding portion (P) of inner surface of said cap (4).

6. A device, according to claim 2, wherein said sensor means (21) detect also the electromagnetic radiation spectrum, including infrared range.

7. A device for supplying and controlling a light source in a half-dipped signaling lamp, the signaling lamp including:
a base support embedded in the ground;
at least one light source (3) housed in said base support;
a cap (4), protruding from the ground, removably fastened to said base support; at least one window seat (5a, 5b) made in said cap;
an optical prism (6a, 6b) connected to said window seat for directing outwards a light beam emitted by the light source (3),
characterized in that it includes:
sensor means associated to said optical prism (6a, 6b) for detecting the intensity of the light radiation emitted by said light source (3) reflected by said optical prism (6a, 6b), directing inwards; and a central control unit, which receives the signals coming from the sensor means to define the cleanliness degree of the surfaces (16a, 16b) of said optical prism (6a, 6b), turned outwards.

8. A device, according to claim 3, wherein said sensor means (21) detect also the electromagnetic radiation spectrum, including infrared range.

9. A device, according to claim 4, wherein said sensor means (21) detect also the electromagnetic radiation spectrum, including infrared range.
